(19) United States
(12) Patent Application Publication
(10) Pub. No.: US 2013/0284616 A1
(43) Pub. Date: Oct. 31, 2013

(54) CARRIER FOR BEVERAGE CUPS

(71) Applicant: Asean Trading and Shipping Inc., dba Asean Corporation, (US)

(72) Inventors: Kurt Wahrer Anderson, Culver City, CA (US); Bret Alan Chandler, Lake Oswego, OR (US)

(73) Assignee: Asean Trading and Shipping Inc., dba Asean Corporation, Portland, OR (US)

(21) Appl. No.: 13/869,851

(22) Filed: Apr. 24, 2013

Related U.S. Application Data
(60) Provisional application No. 61/638,077, filed on Apr. 25, 2012.

(51) Int. Cl. B65D 71/40; B31B 3/14

(52) U.S. Cl. CPC B65D 71/40; B31B 3/14
USPC 206/193; 493/56; 428/34.2

(57) ABSTRACT

A beverage cup carrier is formed of a single sheet of paperboard, stored flat and then folded into the carrying configuration upon time of use. An array of holes is arranged about a centerline, and first and second fold lines are equally spaced oppositely from the centerline, outside the array of holes and parallel to the first pair of edges to form a base. First and second flaps extend from the fold lines and are folded along the fold lines inward to the base. A handhold cutout is formed at a first end of the first flap, and a tab, generally of the shape of the handhold cutout, at a first end of the second flap. The tab of the second flap is inserted through the slot of the first flap to interlock first and second flaps.

### CROSS REFERENCE TO RELATED APPLICATIONS

This application claims the benefit of U.S. Provisional Application Ser. No. 61/638,077, filed Apr. 25, 2012, hereby incorporated in its entirety by reference.

### BACKGROUND OF THE INVENTION

With the rise of to-go style beverage cups, there has been an increasing need for carriers that can carry multiple beverage cups simultaneously. Currently, there are two styles of carrier that dominate the market: one formed of pulp, the other formed of cardboard assembled and glued.

The pulp based carrier is cheap to manufacture and stores relatively small but one of the drawbacks is the lack of a handle for easy carrying. The cup are placed into the wells of the carrier and by pressing down on the cups, the wells expand and grasp the cup firmly around the bottom. Full beverage cups are top heavy and unless the carrier has a good grasp, there is the chance for the cup to tip over in the carrier. These carriers are also not very reusable, as cups are taken out and inserted back into the carrier the wells expand and break down, no longer grasping the beverage cups securely. The pulp carrier also has the benefit of being completely biodegradable as it is made purely of molded paper pulp.

The other common drink carrier design is one made from cardboard that is assembled and glued into a rectilinear shape with holes in its upper side to receive cups. This design is more expensive, but stores very compactly and has a handle. The carrier is designed in such a way that it stores flat and when expanded creates multiple wells to hold drinks and has a central, vertical handle. The design requires that multiple pieces of cardboard be cut, assembled and glued to make this carrier, and thus is more costly to manufacture. This carrier has advantages over the pulp based in that the cups are supported from the bottom and sides, reducing but not eliminating the chance of top heavy cups tipping over. The carrier also has a handle, making it easier and more comfortable for the user to carry the multiple beverages. As with the pulp carrier, this carrier can be completely biodegradable.

The new version of a carrier addresses the limitations of the previous designs—it is inexpensive to manufacture, it stores compactly, holds the beverage securely, has a handle for ease of use and is completely biodegradable.

### SUMMARY OF THE INVENTION

A beverage carrier comprises a sheet of foldable, stiff material having a generally rectangular shape defined by a first pair of opposite edges and a second pair of opposite edges and having a centerline spaced between the first pair of edges. An array of holes is arranged about the centerline, and first and second fold lines equally spaced oppositely from the centerline, outside the array of holes and parallel to the first pair of edges to form a base. A first flap extends from the first fold line to the first edge of the first pair of opposite edges and a second flap extends from the second fold line to the second edge of the first pair of opposite edges. The first and second flaps are folded along first and second fold lines inward to the base. A handhold cutout is formed at a first end of the first flap, and a tab, generally of the shape of the handhold cutout, at a first end of the second flap. The tab of the second flap is inserted through the slot of the first flap to interlock first and second flaps.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a plan view of an embodiment of the carrier device in a flat, unfolded state as it would be stored.

FIG. 2 is a perspective view of the carrier device of FIG. 1 as in use.

FIG. 3A is a side view of the carrier device of FIG. 1 in an unlocked state for receiving beverage cups.

FIG. 3B is a side view of the carrier device of FIG. 1 in a locked state as a user would carry it.

FIG. 4 is a perspective view of another embodiment the carrier device to carry a single cup.

FIG. 5 is a plan view of another embodiment of the carrier device of FIG. 1 highlighting the circular openings with radial tabs.

FIG. 6 is a perspective view showing the carrier device of FIG. 3 with added slits and pockets for storage.

FIG. 7 is a perspective view of another embodiment of the beverage carrier featuring holes for two cups and trimmed flaps.

FIG. 8 is a plan view of the embodiment as shown in FIG. 7 in unfolded condition.

FIG. 9 is a plan view of another embodiment of the beverage carrier having four beverage holes aligned linearly along the centerline.

FIG. 10 is a plan view of another embodiment of the beverage carrier having four beverage holes arranged in a square pattern symmetrically about the centerline.

### DETAILED DESCRIPTION OF EMBODIMENTS

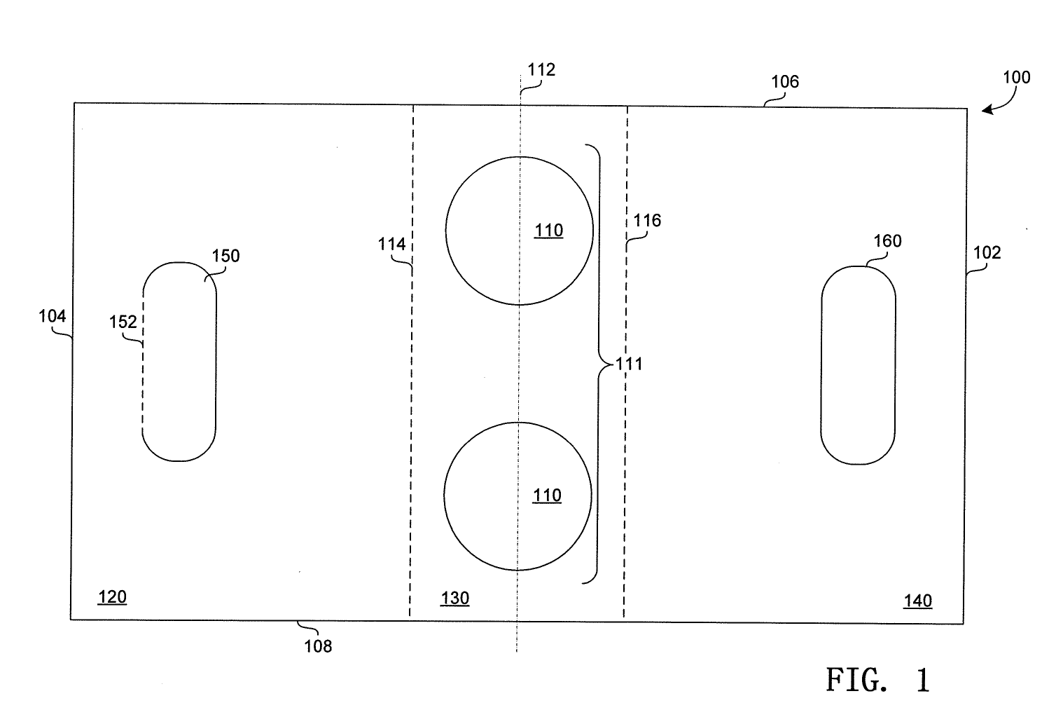

The beverage carrier 100 is formed from a flat rectangular piece of paperboard as shown in FIG. 1. The paperboard sheet is of a suitable stiffness and thickness to support the weight of full beverage cups in the holder while still retaining the ability to be folded. Ideally, the paperboard has a thickness between 0.01 and 0.036 inches. The paperboard used to form the beverage carrier could come in pre-sized rectangular sheets that have been cut to the outer dimensions, defined as the first pair of opposite edges 102 and 104 and the second pair of opposite edges 106 and 108, of the beverage carrier in the un-folded configuration. Alternatively, the beverage carriers can be cut or stamped from a continuous roll of the paperboard. The holes 110 for the insertion of a beverage cup are formed along a centerline 112 of the carrier. Fold lines 114 and 116 are formed in parallel equidistant from the centerline 112 and on opposite sides of the array of holes 111. These lines are scored to allow the user to quickly and easily fold the carrier into the carrying configuration. The two fold lines 114 and 116 define a base 130 of the carrier 100. An oblong cutout 160 is formed on flap 140. An oblong tab 150 is formed on flap 120; a portion of the perimeter of the tab 150 is cut from the carrier but remains attached by the fold line 152. The tab 150 and cutout 160 are positioned symmetrically about the centerline.

There are many methods and ways to form the carrier known in the art. One such way would be to have a die to cut all the features, holes 110, handhold cutout 160, and tab 150, in a single stamping operation. The die also include sections to create fold lines 114 and 116, optionally fold line 152, to allow for a completed carrier to be made in one stamping or pressing operation. If a continuous roll of paperboard was being used, the die would also size the carrier by including cutting portions to define the edges 102, 104, 106 and 108.

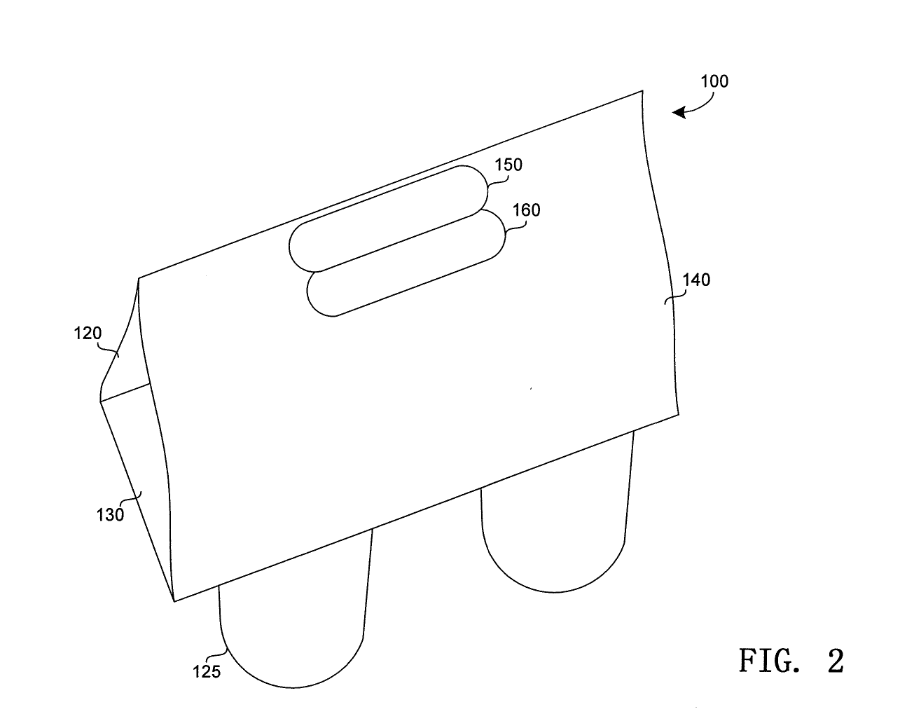

FIG. 2 shows the carrier 100 in the carrying state with beverage cups 125 inserted into the holes 110. Flaps 120 and 140 have been folded inwards on base 130 along fold lines 114 and 116. Tab 150 has been inserted through handhold cutout 160 and folded upwards along fold line 152 to interlock the flaps 140 and 120. The folding of the tab 150 through cutout 160 creates a comfortable handhold for carrying the beverage carrier and securely locks the carrier together preventing movement of the beverage cups relative to the carrier.

To form the carrier from the unfolded, flat configuration to the folded carrying configuration, a user would insert beverage cups 125 in holes 110 then fold flaps 120 and 140 along fold lines 114 and 116 respectively. Tab 150 is inserted through cutout 160 and folded upwards, locking flaps 120 and 140 together. The carrier is then pulled up around the inserted beverage cups 125 and is ready for the user to carry off. Alternatively, the carrier can be pre-folded along the fold lines at the point of sale of the beverages.

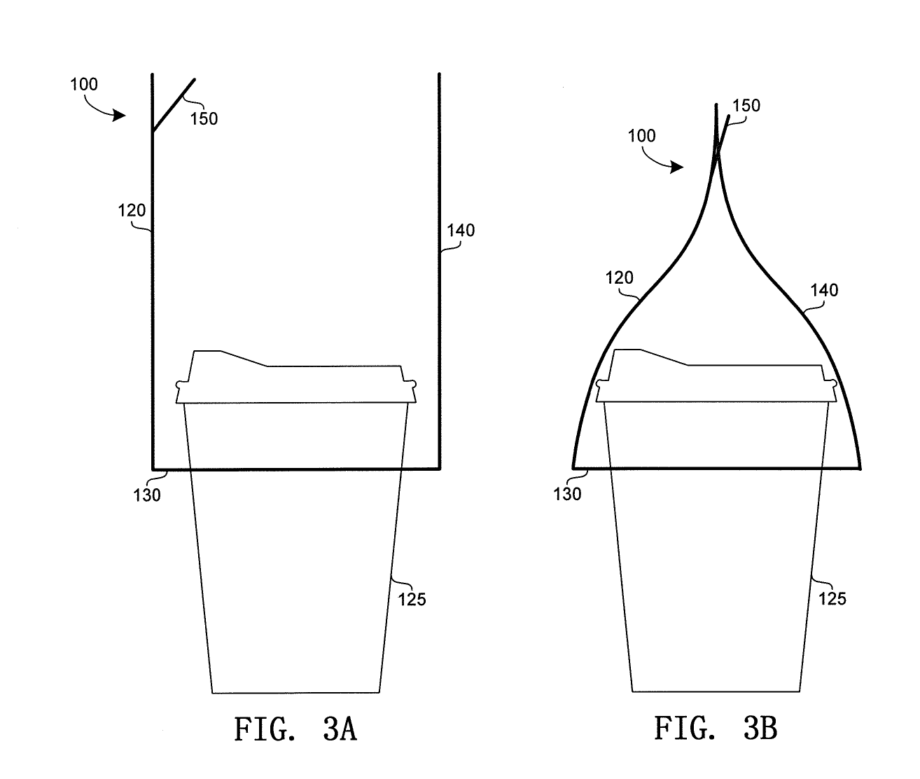

FIG. 3A shows a side view of the carrier 100 with cups 125 inserted and flaps 120 and 140 folded upwards around base 130. Tab 150 has been folded inwards to flap 120 to be inserted through cutout 160.

FIG. 3B shows a side view of the carrier 100 with cups 125 inserted and the flaps 120 and 140 now interlocked by the tab 150 inserted through cutout 160. The flaps 120 and 140 of the carrier are flexible enough to bend around the inserted beverage container if necessary.

The new design for a beverage carrier combines the strengths of the two previous designs and minimizes the weaknesses. This new carrier is inexpensive to produce as it is cut from a single piece of paperboard, can be shaped with minimal work and requires no assembly of any kind. It also stores flatly and compactly in its unfolded state. By holding the cups near their tops by a circular opening, the carrier limits if not eliminates the ability of the beverage cups to tip over and spill. The integrated handle allows the user to carry the multiple beverage cups with ease and minimal effort. As with the previous designs, this new carrier can be completely biodegradable.

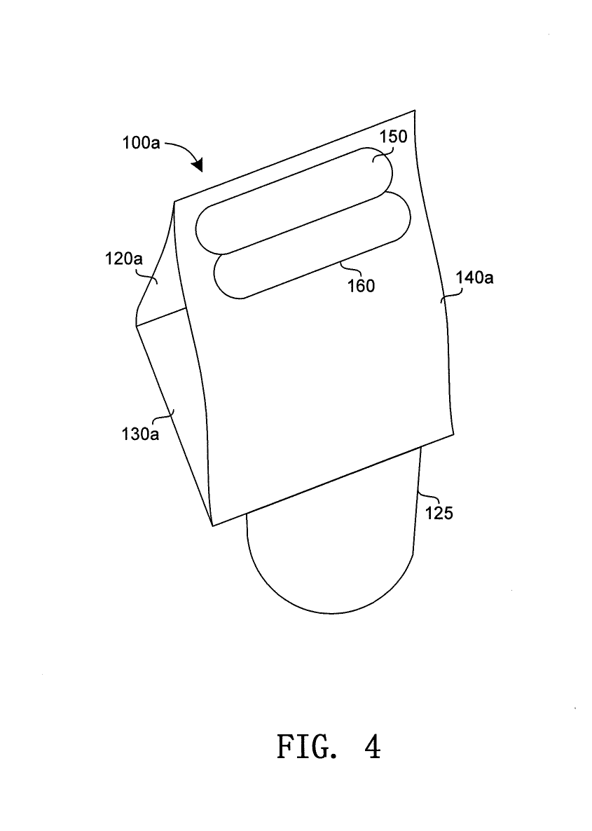

FIG. 4 is another embodiment of the invention, the carrier being configured to carry a single cup. This could be desirous if the user is trying to carry multiple items in a single hand or if the beverage inside is too hot to handle. The carrier 100a consists of the same parts as the previous embodiment but has been scaled for the single beverage cup. Flaps 120a and 140a fold up around base 130a and are interlocked to form the carrier by inserting tab 150 through handhold cutout 160.

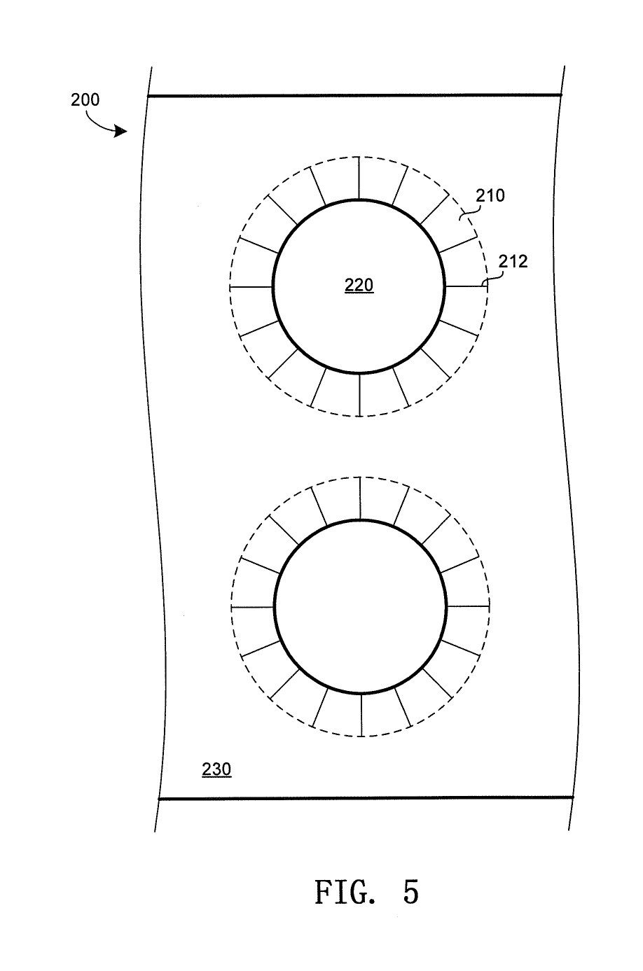

FIG. 5 is another embodiment of the carrier 200. In this embodiment, short, radial cuts 212 are equally spaced around the circumference of the hole 220 in the carrier base 230. The slits 212 form tabs 210 that bend when a beverage cup is inserted into the hole 220. The bent tabs 210 exert radial pressure on the cup to hold it more securely. The tabs 210 would also allow the opening to expand to accommodate larger cups; in this manner a mix of cup sizes can be carried securely in the same carrier.

Another embodiment of the invention allows for the printing of promotional, logo, advertising or other printed material on the outside surface of panels 120 and 140. Another option would be to print on the inside surface of the carrier to provide advertising, promotional or informational text and/or graphics to the user.

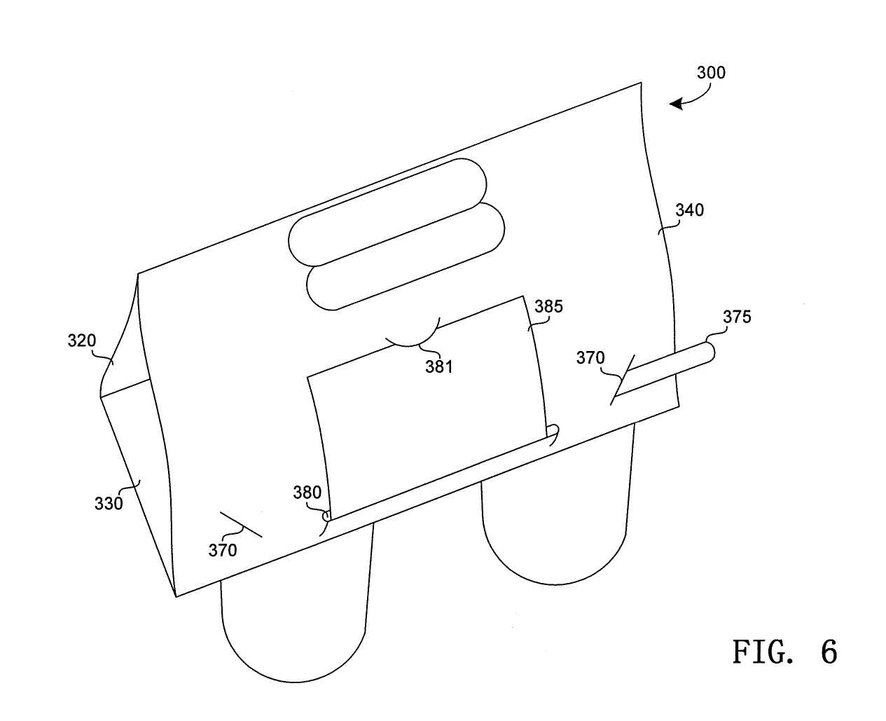

FIG. 6 is another embodiment of the invention featuring means to store beverage accessories. Slits 370 on panel 340 are made so that accessories 375 may be inserted. Accessory 375 could be a straw, stirring stick or utensil. The pressure exerted by the slits during carrying holds the accessories 375 securely to the carrier 300. Slot 380 and tab 381 can also be formed on panel 340. Slot 380 allows a generally flat, thin item 385 to be inserted; the item 385 is then also inserted under tab 381 to secure the item to panel 340 of the carrier 300. The item 385 could be a napkin, card, pamphlet or other similarly sized item.

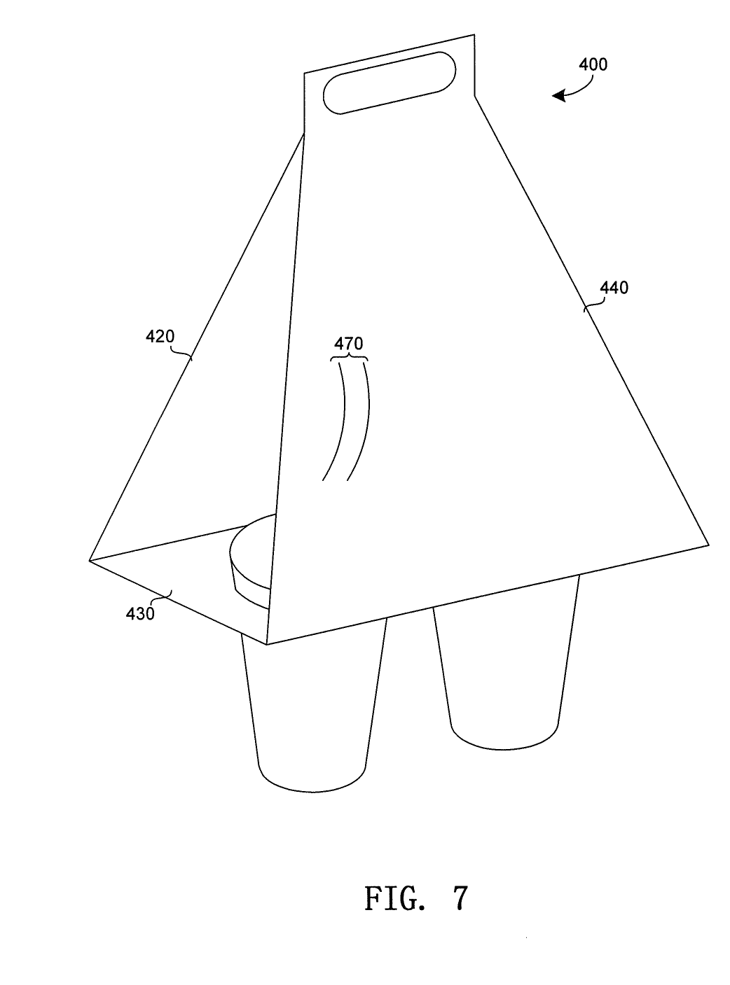

FIG. 7 is another embodiment of the invention. In this embodiment, flaps 420 and 440 have been cut to be trapezoidal shaped. In flap 440, two slits 470 are cut to allow beverage accessories to be inserted and held securely to the carrier 400.

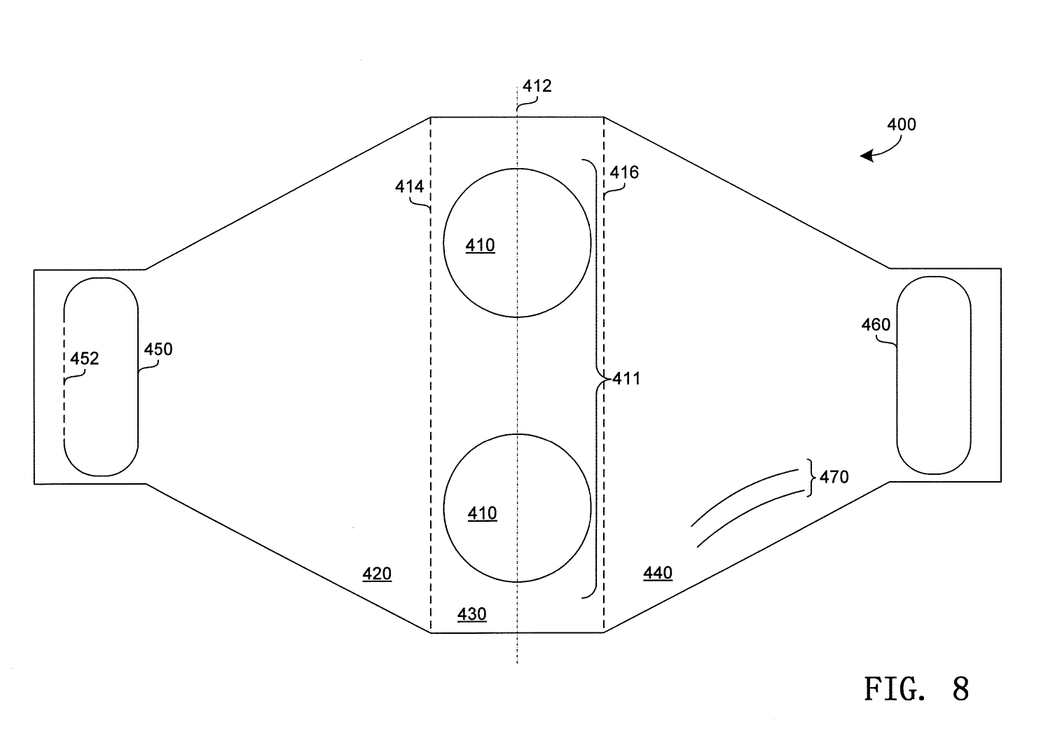

FIG. 8 is a plan view of the embodiment of FIG. 7. FIG. 8 shows the carrier 400 in the unfolded, flat configuration. Flaps 420 and 440 are trapezoidal in shape. As in the previous embodiments, holes 410 are arranged linearly along centerline 412. Parallel fold lines 414 and 416 are equidistant from the centerline 412 and outside the array of holes 411. Handhold cutout 460 is formed on flap 440. Opposite, on flap 420, tab 450 is formed with hinge 452. Slots 470 for beverage accessories are formed on panel 440.

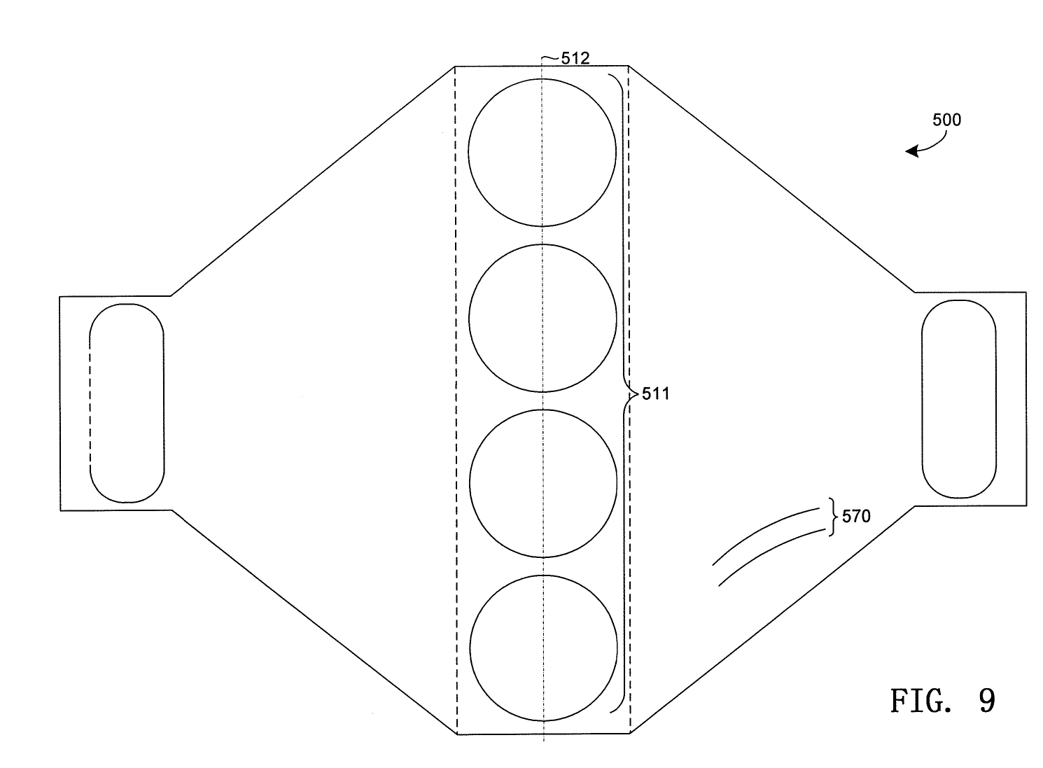

FIG. 9 is another embodiment of the carrier 500, illustrating an array 511 of four holes linearly aligned along the centerline 512. This embodiment also includes the slits 570 for holding beverage accessories.

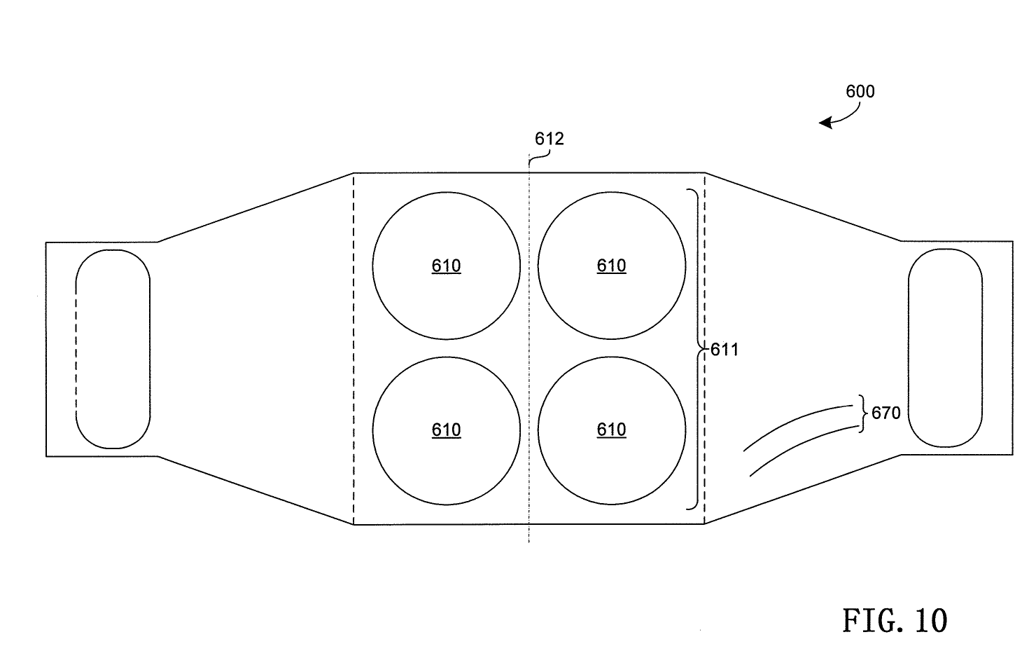

FIG. 10 is another embodiment of the carrier 600, illustrating an array 611 of four holes arranged in a square pattern. The holes 610 are arranged equidistant from the centerline 612 and equidistant from each other. This embodiment also includes slits 670 for beverage accessories.

Having described and illustrated the principles of the invention in a preferred embodiment thereof, it should be apparent that the invention can be modified in arrangement and detail without departing from such principles. We claim all modifications and variation coming within the spirit and scope of the following claims.

1. A method of forming a beverage carrier comprising:
providing a sheet of foldable, stiff material having a generally rectangular shape defined by a first pair of opposite edges and a second pair of opposite edges and having a centerline spaced between the first pair of edges,
forming an array of holes arranged about the centerline,
forming first and second fold lines equally spaced oppositely from the centerline, outside the array of holes and parallel to the first pair of edges to define a base,
forming a first flap extending from the first fold line to the first edge of the first pair of opposite edges,
forming a second flap extending from the second fold line to the second edge of the first pair of opposite edges,
forming a handhold cutout at a first end of the first flap,
forming a tab, generally of the shape of the handhold cutout, at a first end of the second flap,
folding first and second flaps along first and second fold lines inward to the base,
inserting the tab through the slot to interlock first and second flaps.

2. The foldable, stiff material of claim 1, wherein the material is a paperboard having a thickness between 0.01 to 0.036 inches.

3. The array of holes of claim 1, wherein the arrangement of the holes is a line along the centerline.

4. The array of holes of claim 1, wherein the array comprises 2 holes.

5. The array of holes of claim 1, wherein the array comprises 3 holes.

6. The array of holes of claim 1, wherein the array comprises 4 holes.

7. The array of holes of claim 1, wherein each hole of the array has radial slits equally spaced about the circumference.

8. The carrier of claim 1, including at least one slit on at least one of a first or second flap to hold other beverage accessories.

9. A beverage carrier comprising:
a sheet of foldable, stiff material having a generally rectangular shape defined by a first pair of opposite edges and a second pair of opposite edges and having a centerline spaced between the first pair of edges,
an array of holes arranged about the centerline,
first and second fold lines equally spaced oppositely from the centerline, outside the array of holes and parallel to the first pair of edges to form a base,
a first flap extending from the first fold line to the first edge of the first pair of opposite edges,
a second flap extending from the second fold line to the second edge of the first pair of opposite edges,
a handhold cutout at a first end of the first flap,
a tab, generally of the shape of the handhold cutout, at a first end of the second flap,
first and second flaps folded along first and second fold lines inward to the base,
the tab of the second flap inserted through the slot of the first flap to interlock first and second flaps.

10. The foldable, stiff material of claim 9, wherein the material is a paperboard having a thickness between 0.01 to 0.036 inches.

11. The array of holes of claim 9, wherein the arrangement of the holes is a line along the centerline.

12. The array of holes of claim 9, wherein the array comprises 2 holes.

13. The array of holes of claim 9, wherein the array comprises 3 holes.

14. The array of holes of claim 9, wherein the array comprises 4 holes.

15. The array of holes of claim 9, wherein each hole of the array has radial slits equally spaced about the circumference.

16. The carrier of claim 9, including at least one slit on at least one of a first or second flap to hold other beverage accessories.

17. A beverage carrier comprising:
a sheet of foldable, stiff material having a generally rectangular shape defined by a first pair of opposite edges and a second pair of opposite edges and having a centerline spaced between the first pair of edges,
an array of holes arranged about the centerline,
first and second fold lines equally spaced oppositely from the centerline, outside the array of holes and parallel to the first pair of edges to form a base,
a first flap extending from the first fold line to the first edge of the first pair of opposite edges,
a second flap extending from the second fold line to the second edge of the first pair of opposite edges,
a handhold cutout at a first end of the first flap,
a tab, generally of the shape of the handhold cutout, at a first end of the second flap.

18. The foldable, stiff material of claim 17, wherein the material is a paperboard having a thickness between 0.01 to 0.036 inches.

19. The array of holes of claim 17, wherein the arrangement of the holes is a line along the centerline.

20. The carrier of claim 17, including at least one slit on a flap to form a means of hold other beverage accessories.
